(19) United States
(12) Patent Application Publication
(10) Pub. No.: US 2024/0353613 A1
(43) Pub. Date: Oct. 24, 2024

(54) OPTICAL FIBER INCLUDING INTRA-CLADDING BARRIER LAYER

(71) Applicant: OFS Fitel, LLC, Norcross, GA (US)

(72) Inventors: Tristan Kremp, Somerset, NJ (US); Jie Li, Unionville, CT (US); Jiawei Luo, Somerset, NJ (US); Andrei A Stolov, Simsbury, CT (US)

(73) Assignee: OFS Fitel, LLC, Norcross, GA (US)

(21) Appl. No.: 18/688,306

(22) PCT Filed: Aug. 29, 2022
(86) PCT No.: PCT/US22/41937

§ 371 Date: Feb. 29, 2024

Related U.S. Application Data
(60) Provisional application No. 63/238,600, filed on Aug. 30, 2021.

(30) Foreign Application Priority Data
Aug. 29, 2022 (WO) PCT/2022/041937

(51) Int. Cl. G02B 6/028; C03C 3/06; C03C 13/04; G02B 6/036

(52) U.S. Cl. CPC G02B 6/0288; C03C 3/06; C03C 13/046; C03C 2201/31; C03C 2213/00; G02B 6/036

(57) ABSTRACT

A hydrogen diffusion barrier is included as an intra-cladding layer (i.e., a “ring”) within an optical fiber structure. The hydrogen diffusion barrier ring may comprise alumina (or other glass oxides) and is positioned within the fiber cladding at an optimum location with respect to the central core region of the optical fiber. The thickness of the barrier ring may be controlled by fabrication processes to control properties such as hydrogen permeability. Other alkali and alkaline earth metal oxides may be included in the composition of the barrier ring and are useful in preventing crystal formation during the fiber fabrication process.

### CROSS-REFERENCE TO RELATED APPLICATIONS

This application claims the benefit of U.S. Provisional Application No. 63/238,600, filed Aug. 30, 2021 and incorporated herein by reference.

### TECHNICAL FIELD

The present invention generally relates to the field of optical fiber design and, more particularly, to configurations that incorporate an intra-cladding barrier ring to, for example, limit the diffusion of hydrogen toward the core region of the optical fiber, as well as improve the mechanical and thermal properties of the fiber.

### BACKGROUND OF THE INVENTION

Optical fiber-based sensors have become a widely-used technology for various harsh environment applications, such as distributed fiber optical sensing in oil and gas production (e.g., as “downhole” sensors providing information on environmental conditions). Thus, it is imperative for an optical fiber to perform its functionalities without significant degradation in parameters such as attenuation and mechanical strength, particularly when exposed to a harsh environment over an extended period of time. One problem in numerous harsh environment applications is the effect of hydrogen intrusion on the performance of an optical fiber.

The intrusion of hydrogen molecules into the core region of an optical fiber is known to result in hydrogen-induced losses at various wavelengths, with a most pronounced absorption peak centered around 1240 nm. Indeed, hydrogen diffusion has been a well-known problem for the harsh environment sensing applications discussed above. An important characteristic of the molecular hydrogen-induced peaks is their reversibility; i.e., the peaks will reduce and perhaps even disappear as the hydrogen molecules are allowed to diffuse out of the fiber.

While such an out-diffusion of molecular hydrogen can provide some improvement, another loss mechanism in these harsh environmental applications relates to the typical high temperature conditions. In particular, when sufficient thermal energy is available, formation of OH groups can occur as a product of hydrogen and oxygen reaction, in this case generating an irreversible absorption peak at about 1380 nm.

Current solutions include forming an outer coating on the fiber during draw, where carbon coatings have been used. However, effectiveness as a hydrogen diffusion barrier is limited to temperatures less than 150° C. For mitigating hydrogen-induced attenuation, an as-drawn optical fiber can be exposed to a deuterium-rich environment, where the reaction with deuterium results in the development of O-D groups that absorb light at lower frequency than the O—H groups. The consumed reactive sites therefore become less available for the further interaction with H₂. However, H-D exchange diminishes the benefits of deuterium passivation. Furthermore, deuterium passivation does not prevent variations in the short wavelength edge of the usable bandwidth, or the presence of interstitial H₂ attenuation, which makes its use limited to very specific cases.

### SUMMARY OF THE INVENTION

The needs described above are addressed by the present invention, which relates to the field of optical fiber design and, more particularly, to configurations that limit the diffusion of hydrogen toward the core region of the optical fiber.

In accordance with the principles of the present invention, it is proposed to include a hydrogen diffusion barrier as an intra-cladding layer (i.e., a “ring”) within the fiber structure. Referred to at times hereinafter as a “barrier ring”, the intra-cladding layer preferably includes alumina and is positioned within the fiber cladding at an optimum location with respect to the central core region of the optical fiber. The thickness of the barrier ring may also be controlled by fabrication processes to control properties such as hydrogen permeability. Other alkali and alkaline earth metal oxides may be included in the composition of the barrier ring and are useful in preventing crystal formation during the fiber fabrication process.

Alumina is a preferred constituent for the barrier since it exhibits a higher density than the conventional silica material used to form the cladding layer(s), having a density on the order of 3.98 g/cm³ (as compared to a density of 2.19 g/cm³ for conventional silica cladding material). Alumina also exhibits a lower impurity porosity than silica (about 4% lower) and a lower hydrogen permeability. In formation, the barrier ring is typically a silicate glass composition containing up to 20 mol % alumina (the composition containing a non-zero amount of alumina).

Other properties of the barrier ring, such as its coefficient of thermal expansion (CTE) difference with respect to the cladding layer(s), have been found to improve the mechanical strength and fatigue properties of the optical fiber at elevated temperatures (e.g., above 300° C.). For example, the difference in CTE causes the outer cladding layer of the fiber to remain in compression after fiber draw, providing a mechanically stable fiber. The existence of the barrier ring may also function to reduce, if not eliminate, the propagation of cracks within the outer cladding and thus prevent the core region of the fiber from being affected by the presence of these mechanical defects. The inclusion of a barrier ring in accordance with the principles of the present invention has also been found to provide an optical fiber that maintains thermal stability over a wide temperature range (for example, across a range from less than −40° C. to over +85° C.), where thermal stability is known to promote both modal stability (e.g., attenuation, dispersion, and the like), as well as mechanical reliability. As mentioned above, when this type of fiber is used in downhole sensing applications, the stability of modal and physical properties in this harsh environment is of critical importance.

Advantageously, alumina-doped silica material is UV transparent and will not affect fabrication steps related to the formation of UV-induced structures such as Bragg gratings or long period gratings within the fiber core region. Transparency within other wavelength ranges of interest (for example, IR) may be useful for particular applications. For the purposes of the present invention, transparency at a particular wavelength does not require 100% transparency, but a value sufficient to allow for an inscription beam to pass through and perform writing of a grating along the fiber's core.

An exemplary embodiment of the present invention may take the form of an optical fiber comprising an optical core region, an inner cladding layer, a barrier ring surrounding the inner cladding, and an outer cladding layer surrounding the barrier ring. The interior edge of the barrier ring is disposed at a distance R₁ from the center of the optical core region, with its outer radius positioned at a distance R₂ (>R₁) that provides a desired cross-sectional area. The barrier ring is formed of a silicate glass including an oxide material with a density greater than silica.

A particular embodiment may be defined as an optical fiber where the barrier ring is particularly configured to reduce the diffusivity of hydrogen toward the center of the optical core region. A suitable hydrogen diffusion barrier ring may comprise a silicate glass including a concentration of aluminum oxide selected to achieve a defined level of diffusivity reduction.

Other and further embodiments of the present invention will become apparent during the course of the following discussion and by reference to the related drawings.

### BRIEF DESCRIPTION OF THE DRAWINGS

Referring now to the drawings, where like numerals represent like parts in several views:

FIG. 1 shows a cross-section of an exemplary optical fiber formed to include a barrier ring in accordance with the principles of the present invention;

FIG. 2 is a plot illustrating the difference in hydrogen diffusion into the core region of a fiber, based on factors including the placement of the barrier ring and diffusion coefficient of the material selected to be used as the barrier ring;

FIG. 3 is a graph depicting the fraction of the propagating optical power that encroaches into the barrier ring as a function of the thickness of the ring; and

FIG. 4 is a graph showing the relationship between barrier ring placement and its cross-sectional area in comparison to the enter fiber cross-sectional area.

### DETAILED DESCRIPTION

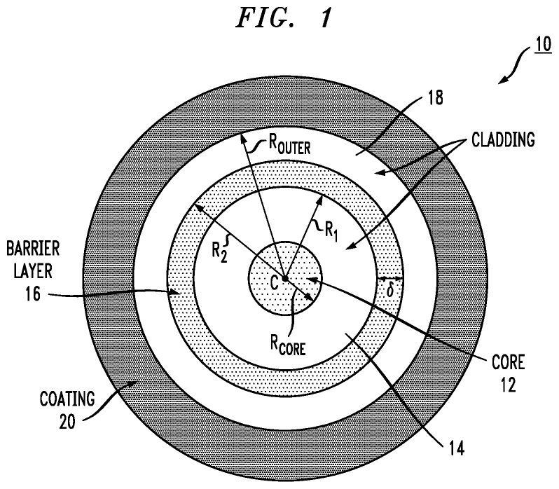

FIG. 1 is a cut-away side view of an exemplary optical fiber 10 formed in accordance with the principles of the present invention to include an intra-cladding barrier ring. As shown, optical fiber 10 comprises a core region 12, surrounded by an inner cladding layer 14. A barrier ring 16 is shown as formed as a layer that surrounds inner cladding layer 14, with an outer cladding layer 18 formed to surround barrier ring 16. A protective coating 20 is shown as surrounding outer cladding layer 18. While not shown in this view, it is to be understood that a complete fiber design may further include additional coating and jacket layers in its final form. Core region 12 may comprise silica, or a doped silica useful in particular waveguiding applications (Ge-doped SiO₂ being one possible choice). Inner cladding layer 14 and outer cladding layer 18 generally comprise silicon dioxide (SiO₂), also referred to as “silica”. Barrier ring 16 is preferably a silicate glass containing aluminum oxide (Al₂O₃), and perhaps additional glass-based oxides (such as the alkali and alkaline metal oxides mentioned above) that may be included to assist in the formation of a high-quality glass with a relatively high concentration of Al₂O₃.

As discussed in detail below, an aspect of the present invention is the ability of barrier ring 16 to slow down the in-diffusion of hydrogen into waveguiding core region 12 of optical fiber 10. Parameters useful in determining an effective configuration of barrier ring 16 with respect to slowing down hydrogen in-diffusion are shown in FIG. 1 as the core radius (R_{core}), the inner radius of barrier ring 16 (R₁), and the outer radius of barrier ring 16 (R₂). The cross-section area (CSA) of barrier ring 16 is thus defined by the following:

$${CSA}_{ring} = π \{ {( {R}_{2} )}^{2} - {( {R}_{1} )}^{2} \} .$$

Silicate glass containing a relatively high concentration of aluminum oxide (e.g., a non-zero concentration of aluminum oxide, up to about 20 mol % Al₂O₃, for example) is a preferred hydrogen diffusion barrier material primarily as a result of its physical properties, specifically in terms of its high density, low ionic porosity, and low hydrogen permeability (all in comparison to the properties of pure silica). One exemplary composition of barrier ring 16 may comprise a silicate glass having a non-zero concentration of aluminum oxide, up to about 20 mol % Al₂O₃ (for example) and an additional 25 mol % of alkali metal oxides (e.g., Na₂O or K₂O) or alkaline earth metal oxides (e.g., MgO, CaO, BaO). The 20 mol % of Al₂O₃ should not be considered as a limit on the actual concentration that may be used; rather, the 20 mol % has been found to be an acceptable level that provides the desired effect of reducing hydrogen diffusivity without exhibiting an elevated refractive index (related to the inclusion of Al₂O₃) that may perturb the modal properties of the optical signal propagating along core region 12 of optical fiber 10. It is contemplated that other concentrations of Al₂O₃ may be used based on, at least, the capabilities of the optical preform fabrication process, combination of additional metal oxides included in the silicate glass, etc.

The higher density and smaller ionic porosity of Al₂O₃ (and the other metal oxides noted above) with respect to the silica (SiO₂) glass use to form the cladding layers has been found to impede the transport of molecular hydrogen (as well as hydrogen ions), affording lower hydrogen permeability. It has been found that similar behavior occurs in silicate glasses containing high Al₂O₃ concentration. For example, the density of an exemplary alumina-based barrier ring may be up to 11% higher than pure silica glass, while the ionic porosity of the same material may be 4% less than pure silica glass. The barrier ring itself may have a hydrogen permeability that is approximately four orders of magnitude lower than that of the standard silica cladding material.

Regarding the placement of the barrier ring with respect to the core, for a given CSA of the ring, the reduction in hydrogen diffusivity provided by the ring has been found to increase as the ring is positioned closer to the core. In one simulation, it was found that shifting the location of R₁ (see FIG. 1) from 50 μm to 15 μm (while maintaining the same CSA of the barrier ring and fiber diameter) reduces the hydrogen diffusion time by a factor of two. A value for R₁ as low as about 10 m, or up to about 60 m, are another possible alternatives. It is to be understood however, that a spacing gap is necessary between the outer edge of the core (shown as R_{core} in FIG. 1) and the barrier ring so that the mode guiding properties of the core are not impacted by the relatively high refractive index properties of the significant alumina content in the barrier ring; that is, a certain thickness of inner cladding layer 14 is necessary to surround core region 12 so as to maintain optical field confinement of the propagating mode.

The overall properties of the barrier ring are primarily related to controlling the diffusion rate of (unwanted) hydrogen through the fiber and into the core region. H₂ permeability, the diffusion rate of barrier material, barrier start and end radii relative to the core, and CSA of the barrier ring are considered to be important design factors for the barrier ring. The overall diffusion time for H₂ in the environment to reach the fiber core in a theoretical analysis is considered to be useful in describing the efficacy of the barrier ring.

H₂ permeability (or diffusion rate) also plays a critical role in preventing environmental H₂ from interacting with the fiber core. For example, for the same physical properties of a given barrier ring, H₂ diffusion time can be delayed by a factor of two (2) when the diffusion rate of the barrier ring material is ten (10) times lower, as compared to delayed by a factor of 80 when the diffusion rate is 1000 times lower. The H₂ permeability difference between silica and the barrier ring can vary from about two (2) to five (5) orders of magnitude as a function of the barrier ring material (e.g., the mol % of Al₂O₃ included in the silicate glass of the barrier ring).

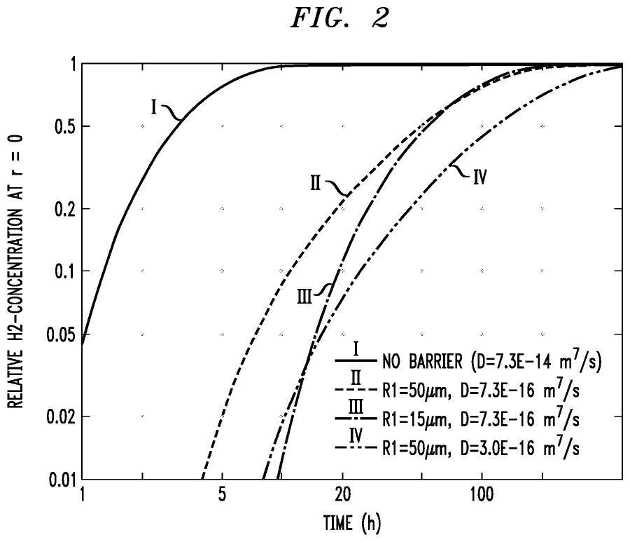

Barrier material positions and CSA are presumed to play secondary roles in increasing H₂ diffusion time, due to real-world limitations in fiber geometry and waveguide designs. For a given barrier material and CSA, moving the barrier ring closer to the core can increase the H₂ diffusion time by up to a factor of three. FIG. 2 contains a set of plots illustrating this aspect of the present invention. In particular, FIG. 2 graphs the relative hydrogen concentration at the center of core region 12 as a function of time (measured in hours). Plot I is associated with a prior art, conventional fiber that does not include a barrier ring. Plots II, III, and IV are associated with different configurations of barrier ring 16, in terms of both separation from the center of core region 12 (defined by the inner radius location R₁ of barrier ring 16) and the diffusion coefficient D of the barrier ring (a known function of the concentration of Al₂O₃ within the barrier ring).

As expected, an increased Al₂O₃ concentration (i.e., reduced diffusion coefficient D) is found to slow down the diffusion of H₂ into core region 12. Quantitatively, in comparison to the prior art plot I, a barrier ring 16 with a value D=7.3·10⁻¹⁶ m²/s (which is 100 times lower than standard silica) increases diffusion times by more than one order of magnitude, depending on the exact ring location. In particular, plot II illustrates the H₂ diffusion when barrier ring 16 is positioned relatively far away from core region 12 (R₁=50 m), as compared to plot III, where barrier ring 16 is located closer to core region 12 (R₁=15 m). The data shown here lead to the conclusion that positioning barrier ring 16 in relatively close proximity to core region 12 (plot III) extends the time period until the H₂ concentration in the core reaches a certain level. Also interesting to note is the fact that reducing inner radius R₁ from 50 μm to 15 μm provides a configuration that is more efficient in blocking an early-stage hydrogen diffusion than reducing the value of the diffusion coefficient (D) from 7.3·10⁻¹⁶ m²/s to 3.0·10⁻¹⁶ m²/s. This is evident by a comparison of the results shown in plot III to those of plot IV. Thus, presuming a design having a fixed D and CSA, a preferred embodiment of the present invention should place barrier ring 16 as close to core region 12 as possible, without impairing the optical modes of the signal propagating through core region 12. As mentioned above, values for R₁ on the order of about 10 μm to upwards of about 60 μm may be used as well.

In summarizing the benefits of including an intra-cladding barrier ring, optimum results occur when making the ring as thick and non-diffusive as possible. Also, locating the ring as close as possible to the core (without interfering with the propagating modes) provides optimum results in terms of preventing hydrogen from reaching the core region. A study of improvement as a diffusion barrier may take place by measuring the time it takes for a predetermined concentration (Cₒᵤₜₑᵣ) of H₂/D₂ to reach the center C of core region 12. In a conventional fiber without a barrier ring, it takes T₅%=1.03 hours for the center of core 12 to each a 5% level of the concentration Cₒᵤₜₑᵣ, with an outer radius Rₒᵤₜₑᵣ=62.5 μm. Forming barrier ring 16 to exhibit a diffusion constant that is ten times greater than the surrounding cladding has been found to double the T₅% time; further increasing the diffusion constant to a thousand times greater yields a T₅% value of about 85.8 hours.

Alternatively, instead of modifying the diffusion constant of the barrier ring material, it has been found that doubling the ring area increases the T₅% value to the range of 10-22 hours. In reviewing all of these parameters, if the CSA of barrier ring 16 is to remain as a fixed quantity, it may be best to position barrier ring 16 as close to core region 12 as possible.

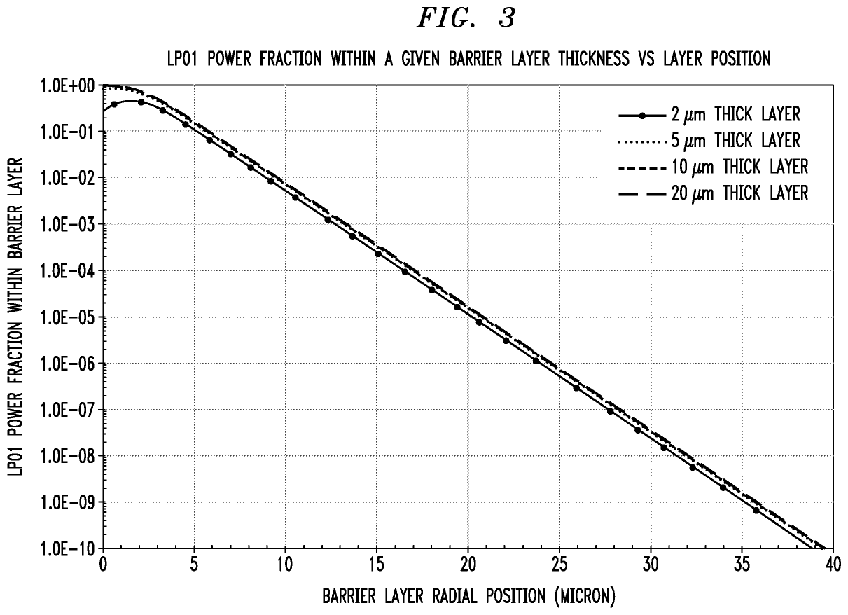

As mentioned above, the value of the inner radius R₁ for barrier ring 16 as well as the thickness δ of ring 16 (δ=R₂−R₁), are limited by an acceptable optical field presence within barrier ring 16 (related to the optical signal propagating along core region 12). FIG. 3 is a graph depicting the fraction of the fundamental mode LP₀₁ power within barrier rings of different values of δ, where the LP₀₁ power fraction within a given thickness δ, based on the modulus |E(r)| of the complex-valued electric field E(r) of the fundamental mode at radial position r, is defined as follows:

$$power fraction = \frac{{\int }_{{R}_{1}}^{{R}_{1} + δ} {\vert E ( r ) \vert}^{2} rdr}{{\int }_{0}^{{R}_{outer}} {\vert E ( r ) \vert}^{2} rdr} .$$

The illustrated data is associated with a conventional step-index single mode fiber (SMF) having a core diameter of 8.2 μm and core refractive index that is 0.0052 higher than the refractive index of the cladding. In reviewing the displayed data, if a relative power limit of 10⁻⁵ in barrier ring 16 is desired, the barrier ring should be located about 20 μm from the center of the core. It is to be noted that for layer thicknesses between δ=2 μm and δ=20 μm, there is only a minimal change in the power fraction resident within the barrier ring.

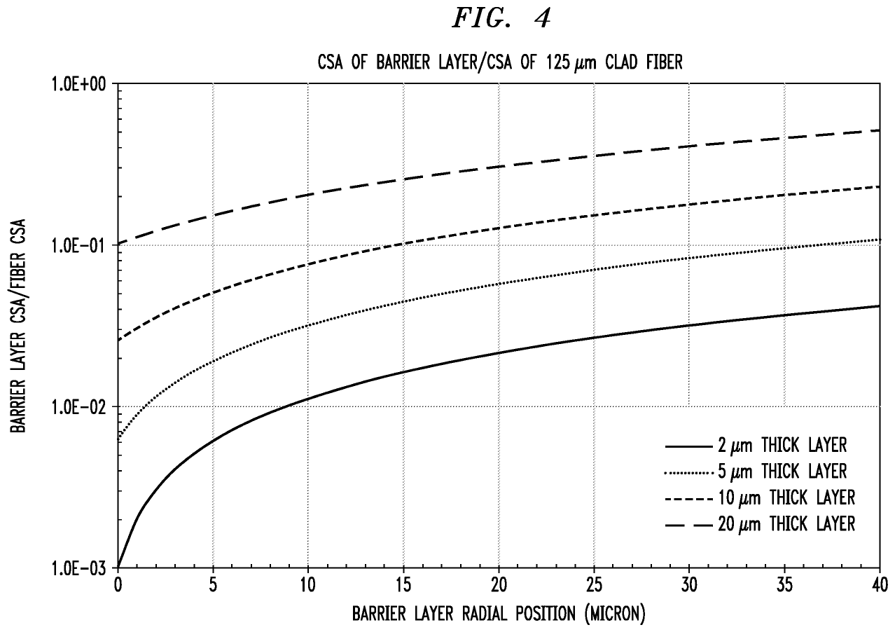

FIG. 4 plots the CSA fraction for the exemplary thickness values of δ identified above, as a function of the barrier ring position with respect to the center C of core region 12. The data was developed for a conventional optical fiber having a diameter of 125 μm. The “CSA fraction” is defined here as the ratio of the barrier layer CSA and the total CSA of the fiber itself. That is,

$$CSA fraction = \frac{{\int }_{{R}_{1}}^{{R}_{1} + δ} rdr}{{\int }_{0}^{{R}_{outer}} rdr} = \frac{( {R}_{1} + {R}_{2} ) δ}{{R}_{outer}^{2}} = \frac{{R}_{2}^{2} - {R}_{1}^{2}}{{R}_{outer}^{2}} .$$

The data of FIG. 4 shows that positioning a relatively thick barrier ring far from the fiber core requires a proportionally higher CSA fraction to function as an effective hydrogen barrier. The fractional CSA is proportional to both δ and the barrier ring center radius (R₁+R₂)/2.

Besides the physical properties of the barrier ring (i.e., its thickness, distance from the core, and placement with respect to the outer edge of the cladding) as discussed above, the effectiveness of the barrier ring with respect to slowing down H₂ diffusion is impacted by the choice of the barrier ring material itself. Thus, as mentioned above, alumina is a preferred choice, although alkali metal oxides or alkaline metal earth oxides may be used. For the latter, other properties of barrier ring 16 important for a particular application need to be considered. As mentioned above and discussed in detail below, the CTE of the barrier ring with respect to that of the surrounding cladding layers may be important when it is desired to have the outer layers exhibit a residual compressive stress after fiber draw. UV (and/or IR) transparency is also important if an application requires the formation of gratings within the core region.

Barrier ring 16 can also serve as a getter, reacting with H₂ in a manner that results in additional benefits. In particular, there are point defects that are created in the barrier ring during fiber draw, such as non-bridging oxygen hole center (NBOHC) defects from both Si—O and Al—O networks, and strained bonds such as (Si—O, Al—O, Si—F, Si—Cl, Al—F, Al—Cl, etc.). These point defects can react with H₂ molecules to form immobile —OH, Si—H, and the like. The concentration of these point defects determines the chemical reactivity of the created barrier ring with H₂. Based on simulation results similar to those discussed above, if a barrier ring has an H₂ diffusivity that is two orders of magnitude less than the silica cladding material in a 125 μm diameter silica fiber, a ring area of about 2200 μm² can reduce the time it takes for H₂ to reach a certain concentration at the core center by a factor of 10. If the barrier ring has a diffusivity that is three orders of magnitude lower (while maintaining the same 2200 μm² area), the time delay can increase by a factor of 80.

It is to be understood that a barrier ring of the inventive structure may take the form of a contiguous set of adjacent layers, perhaps of different material composition and/or CSA. The use of adjacent layers (forming a multi-layer barrier ring) may be controlled to impact the hydrogen diffusivity, as well as the structural properties of the fiber.

To maximize the comprehensive effect of barrier and getter, it has been found that the barrier ring chemical composition and fiber draw conditions play critical roles, with the understanding that there is an inherent trade-off between these two conditions. For example, increasing the draw tension can increase the concentration of defect sites, while also increasing the H₂ permeability due to the more porous structure. Additionally, the fabrication technique utilized to create this intra-cladding barrier layer may impact the properties of the final structure. Advantageously, conventional fabrication processes well-known in the art may be used to incorporate barrier ring 16 (first interrupting the creation of the cladding, and thereafter restarting the cladding formation process). Techniques such as, but not limited to, modified chemical vapor deposition (MCVD), plasma chemical vapor deposition (PCVD), vapor axial deposition (VAD), outside vapor deposition (OVD), sol gel, glass frit deposition, or a “tube-in-tube” process may also be used.

In one embodiment, barrier ring 16 may be used in the formation of a single mode fiber (SMF), which typically has a value for R_{core} of less than about 10 μm. In typical SMF designs, core region 12 includes a germanium dopant. By virtue of including barrier ring 16 in accordance with the teachings of the present invention, such a germanium-doped SMF may be used in hydrogen-containing environments, which had previously not been an option in many environments. Hence, the SMF including an intra-cladding barrier ring may provide an improved level of hydrogen resistance over conventional SMFs, and also be more cost competitive than a pure silica core fiber. Similar benefits may be found when incorporating barrier ring 16 with a multi-mode fiber (MMF) configuration.

In further accordance with the principles of the present invention, barrier ring 16 may be formed to exhibit a set of critical properties beyond slowing down the diffusion of hydrogen toward core region 12. For example, barrier ring 16 is preferably configured of UV (and/or IR) transparent materials that permit a standard write-through process to be used to form Bragg or long-period gratings in core region 12. Barrier ring 16 may also be configured to improve the mechanical reliability of the as-drawn fiber over the prior art, as well as increase the workable temperature range of fiber 10 (the latter being an important feature for downhole sensing applications, for example). These critical properties may include one or more of the following: density, ionic porosity, CTE, viscoelastic behavior above glass transition, index of refraction, and UV transparency (in some cases, transparency at other wavelengths—such as in the IR band—is desired as well).

The CTE and viscoelastic behavior, as well as fiber draw conditions, influence the creation of residual stresses that are thereafter “frozen” (i.e., immobilized) within the drawn fiber. Compressive residual stress, attributed to the inclusion of barrier ring 16, can improve the strength and fatigue properties of the fiber. This is especially important at elevated temperatures, up to and beyond about 300° C., where chemically-induced glass corrosion is accelerated. Indeed, by virtue of outer cladding layer 18 remaining in compression after fiber draw, corrosion and the propagation of surface cracks on the fiber are impeded and barrier ring 16 may be thought of as a barrier to crack propagation as well as hydrogen diffusion. In the case of crack formation and propagation, this barrier may not necessarily coincide with the ring location, especially if the ring is under tensile stress.

In evaluating the mechanical reliability of the inventive optical fiber at the elevated temperatures that may be encountered within a harsh environment, its fatigue resistance factor (referred to as the n-value) may also be controlled by this compressive residual stress that is related to the inclusion of the barrier ring. The n-value is derived from dynamic tensile strength test data, and in some cases is also referred to as the “stress corrosion parameter.” It is calculated from measurements of the applied stress and the time to failure. The n-value is used in modeling to predict how long it will take a fiber to fail when it is under stress in certain environments. The industry minimum requirement for the dynamic fatigue stress corrosion factor (n-value) is 18. In this regard, the dynamic fatigue stress corrosion factor provides an indication of how fast a flaw in the glass fiber's silica structure propagates under strain. With respect to the inventive fiber, the specific n-value may be a function of the characteristics of the barrier ring itself. The temperature dependence is influenced by certain factors, where a value of n>>20 is considered to be critical to ensure fiber reliability at elevated temperatures (as compared to standard conventional value of n˜18). Additionally, maintaining a constant n-value is considered to be a requirement for operation over extended periods of time (particularly in high temperature environments). In this case, the n-value is most likely dictated by the process of degradation of the glass coating interface and stress relaxation associated with the barrier ring.

### Examples

The improvement by incorporating an alumina ring as a barrier for hydrogen diffusion has been studied with respect to multimode fibers with R_{core}=31.25 μm and Rₒᵤₜₑᵣ=62.5 μm, under a set of two different aging conditions.

A first set of aging conditions includes: (1) using a forming gas of 5% H₂ and 95% N₂; (2) using a gas pressure of 1000 psi; (3) an ambient temperature of 50° C.; and (4) aging time of 24 hours. A second set of aging conditions used the same values for (1), (2), and (4), but for condition (3), a higher ambient temperature of 100° C. was employed.

| | BAR- | | α after | NET | α after | NET |
|---|---|---|---|---|---|---|
| | RIER | α, as | aging at | CHANGE | aging at | CHANGE |
| | RING | drawn | 50° C. | Δα | 100° C. | Δα |
| @ 1245 | | | | | | |
| nm peak | | | | | | |
| | Not | 0.82 | 22.23 | 21.41 | 35.99 | 35.17 |
| | present | | | | | |
| | Present | 0.45 | 14.37 | 13.92 | 34.91 | 34.46 |
| % | | | 35% | 35% | 3% | 2% |
| improved | | | | | | |
| @ 1420 | | | | | | |
| nm peak | | | | | | |
| | Not | 0.767 | 6.87 | 6.103 | 88.89 | 88.123 |
| | present | | | | | |
| | Present | 0.86 | 5.44 | 4.58 | 81.70 | 80.84 |
| % | | | 21% | 25% | 8% | 8% |
| improved | | | | | | |

| | | | α after | | α after | |
|---|---|---|---|---|---|---|
| @ | | | aging | NET | aging | NET |
| 1420 nm | BARRIER | α, as | at | CHANGE | at | CHANGE |
| peak | RING | drawn | 50° C. | Δα | 100° C. | Δα |
| | Not | 0.767 | 6.87 | 6.103 | 88.89 | 88.123 |
| | present | | | | | |
| | Present | 0.86 | 5.44 | 4.58 | 81.70 | 80.84 |
| % | | | 21% | 25% | 8% | 8% |
| improved | | | | | | |

The above tables summarize the results of attenuation measurements (attenuation α in unit dB/km) of three sample fibers for the conditions of “before” and “after” aging in hydrogen under the two sets of defined conditions (the results averaged for a set of three individual fibers with the same parameters). It is known that an attenuation peak at 1245 nm is attributed to the concentration of molecular hydrogen that has diffused into the core of the fibers, while the 1420 nm attenuation peak is associated with OH groups in the fiber core, formed as a product of hydrogen interaction with the glass.

The largest reduction in the amplitude of the 1245 nm attenuation peak (i.e., the molecular hydrogen peak) under the first set of aging conditions is shown in the tables and evidenced in the plots of FIG. 3 as 35%, while that the largest value associated with the 1420 nm attenuation peak (OH) is 25%. It is to be noted that the test fibers were not specifically created to include a barrier ring of optimized composition, and yet was able to provide an increase of 35% over the prior art.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like, whether or not qualified by a term of degree (e.g. approximate, substantially or about), may vary by as much as ±10% from the recited amount.

The present disclosure has been described with reference to exemplary embodiments thereof. All exemplary embodiments and conditional illustrations disclosed in the present disclosure have been described with the intent to assist in the understanding of the principles and concepts of the present disclosure by those skilled in the art to which the present disclosure pertains. Therefore, it will be understood by those skilled in the art that the present disclosure may be implemented in modified forms without departing from the spirit and scope of the present disclosure. Although numerous embodiments having various features have been described herein, combinations of such various features in other combinations not discussed herein are contemplated to be within the scope of the embodiments as defined by the claims appended hereto.

What is claimed is:

1. An optical fiber comprising:
an optical core region, defined as having a center C and a radius R_{core};
an inner cladding layer, comprising silica material, surrounding the optical core region;
a barrier ring surrounding the inner cladding layer, the barrier ring having an inner radius disposed at a distance R₁ from the center of the optical core region and an outer radius at a distance R₂(>R₁) from the center of the optical core region, the barrier ring comprising a silicate glass including an oxide material with a density greater than silica; and
an outer cladding layer surrounding the barrier ring.

2. The optical fiber as defined in claim 1 wherein the barrier ring comprises a silicate glass including a concentration of an oxide material sufficient to reduce hydrogen diffusivity into the center C of the optical core region.

3. The optical fiber as defined in claim 2 where R₁ exhibits a value between about 10 μm and 60 μm.

4. The optical fiber as defined in claim 1 wherein the barrier ring comprises materials that are transparent to UV radiation.

5. The optical fiber as defined in claim 1 wherein the oxide material included in the barrier ring comprises at least aluminum oxide.

6. The optical fiber as defined in claim 5 wherein a composition of the barrier ring further includes a nonzero concentration of an alkali metal oxide.

7. The optical fiber as defined in claim 5 wherein a composition of the silicate glass further includes a nonzero concentration of an alkaline earth metal oxide.

8. The optical fiber as defined in claim 1 wherein the barrier ring includes a concentration of the oxide material that is sufficient to provide a difference in the coefficient of thermal expansion (CTE) between the barrier ring and the outer cladding layer, so as to maintain the outer cladding layer in a compressive state after fiber draw.

9. The optical fiber as defined in claim 8 wherein the CTE of the barrier ring is sufficient to provide mechanical reliability of the optical fiber over the temperature range from at least −40° C. to +85° C.

10. The optical fiber as defined in claim 8 wherein the CTE of the barrier ring is sufficient to provide mechanical reliability of the optical fiber at temperatures in excess of +300° C.

11. The optical fiber as defined in claim 1 wherein the barrier ring comprises a plurality of layers separated by cladding material, each layer including a defined concentration of the oxide material.

12. The optical fiber as defined in claim 1 wherein the barrier ring exhibits a uniform concentration of the oxide material from R₁ to R₂.

13. The optical fiber as defined in claim 1 wherein the barrier ring exhibits a radially varying concentration of the oxide material from R₁ to R₂.

14. The optical fiber as defined in claim 1 wherein the barrier ring is transparent to wavelengths used to create grating structures in the optical core region.

15. An optical fiber comprising
an optical core region, defined has having a center C and a radius R_{core};
an inner cladding layer comprising silica material and disposed to surround the optical core region;
a hydrogen diffusion barrier ring disposed to surround the inner cladding layer, the hydrogen diffusion barrier ring comprising a silicate glass including a concentration of aluminum oxide selected to reduce diffusion of hydrogen toward the center C of the optical core region; and
an outer cladding layer surrounding the hydrogen diffusion barrier ring.

16. The optical fiber as defined in claim 15 wherein the hydrogen diffusion barrier ring comprises materials that are transparent to UV radiation.

17. The optical fiber as defined in claim 15 wherein the concentration of aluminum oxide is a non-zero amount up to about 20 mol %.

18. The optical fiber as defined in claim 15 wherein the hydrogen diffusion barrier ring further comprises an alkali metal oxide selected from the group consisting of: Li₂O, Na₂O, and K₂O.

19. The optical fiber as defined in claim 15 wherein the hydrogen diffusion barrier ring further comprises an alkaline earth metal oxide selected from the group consisting of: MgO, CaO, and BaO.

20. The optical fiber as defined in claim 15 wherein the optical fiber is a multimode fiber and the optical core region comprises a graded-index germanium-doped silica material.
